(19) United States
(12) Patent Application Publication
(10) Pub. No.: US 2010/0255978 A1
(43) Pub. Date: Oct. 7, 2010

(54) METHOD OF MAKING CERAMIC ARTICLES FROM GLASS

(75) Inventors: Anatoly Z. Rosenflanz, Maplewood, MN (US); Jean A. Tangeman, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/599,612

(22) PCT Filed: May 9, 2008
(86) PCT No.: PCT/US08/63255

§ 371 Date: Nov. 10, 2009

Related U.S. Application Data
(60) Provisional application No. 60/917,520, filed on May 11, 2007.

(51) Int. Cl. C03C 8/24; C03B 23/20

(52) U.S. Cl. 501/15; 65/42

(57) ABSTRACT

A method for making an article from glass comprises providing a substrate including an outer surface; providing at least a first glass comprising at least two different metal oxides, wherein the first glass has a T_{g} and Tₓ, and wherein the difference between the T_{g} and the Tₓ of the first glass is at least 5K, the first glass containing less than 20% by weight Si0₂, less than 20% by weight B₂O₃, less than 40% by weight P₂O₅, and less than 50% by weight PbO; heating the first glass at or below ambient pressure to above its T_{g} such that at least a portion of the glass wets at least a portion of the outer surface of the substrate; and cooling the glass to provide an article comprising ceramic comprising the glass attached to the at least a portion of the outer surface of the substrate. The porosity of the ceramic is less than 20% by volume.

### CROSS REFERENCE TO RELATED APPLICATION

This application claims priority to Provisional Application U.S. Ser. No. 60/917,520, filed May 11, 2007, the disclosure of which is incorporated by reference in its entirety herein.

### FIELD

The present invention relates to methods of making ceramic articles from non-traditional glasses.

### BACKGROUND

A large number of glass and glass-ceramic compositions are known. For example, glasses based on PbO and glass formers such as SiO₂ and B₂O₃ are commonly used as sealant glasses. On a weight basis, these sealant glasses typically have large amounts of high molecular weight PbO and relatively small amounts of SiO₂ and B₂O₃. Typically, these glasses are designed such that they do not crystallize during the sealing process (i.e., they do not have a Tₓ) in order to promote efficient sealing,

The majority of oxide glass systems utilize well-known glass-formers such as SiO₂, B₂O₃, P₂O₅, GeO₂, TeO₂, As₂O₃, and V₂O₅ in relatively large amounts to aid in the formation of the glass. Some of the glass compositions formed with these glass-formers can be heat-treated to form glass-ceramics. The upper use temperature of glasses and glass-ceramics formed from such glass formers is generally less than 1200° C., typically about 700-800° C. The glass-ceramics tend to be more temperature resistant than the glass from which they are formed.

Although a large number of metal oxides can be obtained in an amorphous state by melting and rapidly quenching, most, because of the need for very high quench rates to provide amorphous rather than crystalline material, cannot be formed into bulk or complex shapes. Generally, such systems are very unstable against crystallization during subsequent reheating and therefore do not exhibit typical properties of glass such as viscous flow. On the other hand, glasses based on the known network forming oxides (e.g., SiO₂ and B₂O₃) are generally relatively stable against crystallization during reheating and, correspondingly, the “working” range where viscous flow occurs can be readily accessed. Formation of large articles from powders of known glass (e.g., SiO₂ and B₂O₃) via viscous sintering at temperatures above glass transition temperature is well known. For example, in the abrasive industry, grinding wheels are made using vitrified bond to secure the abrasive particles together.

### SUMMARY

In view of the foregoing, we recognize that it is desirable to provide large articles and/or complex shapes comprising non-traditional glass and glass-ceramic compositions.

The present invention provides methods of making articles from non-traditional glasses. The articles can be relatively large (e.g., having x, y, and z dimensions greater than about 500 microns).

A method of the present invention for making an article from glass comprises providing a substrate including an outer surface; providing at least a first glass (e.g., glass sheets, particles (including microspheres), or fibers) comprising at least two different metal oxides (i.e., the metal oxides do not have the same cation(s)), wherein the first glass has a T_{g} and Tₓ, and wherein the difference between the T_{g} and the Tₓ of the first glass is at least 5K, the first glass containing less than 20% by weight SiO₂, less than 20% by weight B₂O₃, less than 40% by weight P₂O₅, and less than 50% by weight PbO; heating the first glass at or below ambient pressure to above its T_{g} such that at least a portion of the glass wets at least a portion of the outer surface of the substrate; and cooling the glass to provide an article comprising ceramic comprising the glass attached to the at least a portion of the outer surface of the substrate. The porosity of the ceramic is less than 20% by volume.

Another method of the invention for making an article from glass comprises providing a substrate including an outer surface; providing at least a first plurality of particles comprising glass (including glass particles), wherein the glass comprises at least two different metal oxides, wherein the glass has a T_{g} and Tₓ, and wherein the difference between the T_{g} and the Tₓ of the glass is at least 5K, the glass containing less than 20% by weight SiO₂, less than 20% by weight B₂O₃, less than 40% by weight P₂O₅, and less than 50% by weight PbO; heating the glass at or below ambient pressure to above its T_{g} such that at least a portion of the glass wets at least a portion of the outer surface of the substrate; and cooling the glass to provide an article comprising ceramic comprising the glass attached to the at least a portion of the outer surface of the substrate. The porosity of the ceramic is less than 20% by volume.

Yet another method of the invention for making an article from glass comprises providing a substrate including an outer surface; providing at least a first glass and a second glass, wherein the first glass comprises at least two different metal oxides, wherein the first glass has a T_{g1} and Tₓ₁, and wherein the difference between the T_{g1} and the Tₓ₁ of the first glass is at least 5K, the first glass containing less than 20% by weight SiO₂, less than 20% by weight B₂O₃, less than 40% by weight P₂O₅, and less than 50% by weight PbO, and wherein the second glass comprises at least two different metal oxides, wherein the second glass has a T_{g2} and Tₓ₂, and wherein the difference between the T_{g2} and the Tₓ₂ of the second glass is at least 5K, the second glass containing less than 20% by weight SiO₂, less than 20% by weight B₂O₃, and less than 40% by weight P₂O₅; heating the glasses at or below ambient pressure to above the higher of T_{g1} and T_{g2} and coalescing the first and second glasses to provide the article. The porosity of the article is less than 20% by volume.

Still another method of the invention for making an article from glass comprises providing at least a first plurality of particles comprising glass, wherein the glass comprises at least two different metal oxides, wherein the glass has a T_{g} and Tₓ, and wherein the difference between the T_{g} and the Tₓ of the glass is at least 5K, the glass containing less than 20% by weight SiO₂, less than 20% by weight B₂O₃, less than 40% by weight P₂O₅, and less than 50% by weight PbO; and heating the glass at or below ambient pressure to above the T_{g} and coalescing at a portion of the first plurality of particles to provide the article. The porosity of the ceramic is less than 20% by volume.

Typically, non-traditional bulk glasses have been prepared by coalescing or sintering particles of glass under pressure generated by uni- or multi-axial loading such as, for example, by hot pressing or hipping. Surprisingly, however, the methods of the invention provide ceramic articles from non-traditional glasses while being carried out at or below ambient pressure. The methods of the invention are therefore more cost effective than methods that must be carried out under pressure, and may be more suitable for mass production.

In another aspect, the present invention provides ceramic articles comprising non-traditional glasses. The ceramic articles comprise a glass comprising

35%-55% by weight Re(I)₂O₃,

0-20% by weight Re(II)₂O₃,

5%-40% by weight ZrO₂, TiO₂, alkali metal oxide, alkaline earth metal oxide, transition metal oxide, or a combination thereof,

0-15% by weight SiO₂, and

more than 70% by weight Re(I)₂O₃, Al₂O₃, and at least one of ZrO₂, TiO₂, alkali metal oxide, and alkaline earth metal oxide collectively;

wherein Al₂O₃ is present in an amount from (% by weight Re(I)₂O₃—10%) to 40% by weight;

wherein the glass has a T_{g} and Tₓ, and wherein the difference between the T_{g} and the Tₓ of the glass is at least 100K.

The ceramic articles of the invention can have at least two dimensions (preferably, x, y, and z dimensions) greater than about 500 microns. They can also have a porosity of less than 20% (or even 15%) by volume.

It has been discovered that these glasses are particularly well-suited for making ceramic articles using the methods of the invention, which are carried out at or below ambient pressure.

As used herein:

“alkali metal oxides” refers to lithium oxide (e.g., Li₂O), sodium oxide (e.g., Na₂O), potassium oxide (e.g., K₂O), and combinations thereof;

“alkaline earth metal oxides” refers to beryllium oxide (e.g., BeO), magnesium oxide (e.g., MgO), calcium oxide (e.g., CaO), strontium oxide (e.g., SrO), barium oxide (e.g., BaO), and combinations thereof;

“ceramic” includes glass, crystalline ceramic, glass-ceramic, and combinations thereof;

“glass” refers to material derived from a melt and/or a vapor phase that lacks any long range crystal structure as determined by X-ray diffraction and/or has an exothermic peak corresponding to the crystallization of the glass as determined by a DTA (differential thermal analysis) as determined by the test described herein entitled “Differential Thermal Analysis”;

“glass-ceramic” refers to ceramic comprising crystals formed by heat-treating glass;

“porosity” refers to a proportion of the non-solid volume to the total volume of material, and is defined by the ratio

$$φ = \frac{{V}_{p}}{{V}_{m}}$$

where Vₚ is the void volume and Vₘ is the total volume of material, including the solid and non-solid parts;

“rare earth oxides” refers to cerium oxide (e.g., CeO₂), dysprosium oxide (e.g., Dy₂O₃), erbium oxide (e.g., Er₂O₃), europium oxide (e.g., Eu₂O₃), gadolinium (e.g., Gd₂O₃), holmium oxide (e.g., Ho₂O₃), lanthanum oxide (e.g., La₂O₃), lutetium oxide (e.g., Lu₂O₃), neodymium oxide (e.g., Nd₂O₃), praseodymium oxide (e.g., Pr₆O₁₁), samarium oxide (e.g., Sm₂O₃), terbium (e.g., Tb₂O₃), thorium oxide (e.g., Th₄O₇), thulium (e.g., Tm₂O₃), yttrium oxide (e.g., Y₂O₃) and ytterbium oxide (e.g., Yb₂O₃), and combinations thereof;

“REO” refers to rare earth oxide(s);

“substrate” refers to any material that the glass will wet (e.g., glasses (the same glass that is being sintered or other glasses), ceramics, metals, intermetallics, and composites thereof) and can be a bulk material, a particulate, a wire, a fiber, a sheet or any molded article;

“T_{g}” refers to the glass transition temperature as determined by Thermal Differential Analysis (DTA); and

“Tₓ” refers to crystallization onset temperature as determined by DTA. In some embodiments, more than one crystallization onset temperature (i.e., Tₓ₁, Tₓ₂, etc.) are present during a typical DTA scan.

Further, it is understood herein that unless it is stated that a metal oxide (e.g., Al₂O₃, complex Al₂O₃.metal oxide, etc.) is crystalline, for example, in a glass-ceramic, it may be amorphous, crystalline, or portions amorphous and portions crystalline. For example if a glass-ceramic comprises Al₂O₃ and ZrO₂, the Al₂O₃ and ZrO₂ may each be in an amorphous state, crystalline state, or portions in an amorphous state and portions in a crystalline state, or even as a reaction product with another metal oxide(s) (e.g., unless it is stated that, for example, Al₂O₃ is present as crystalline Al₂O₃ or a specific crystalline phase of Al₂O₃ (e.g., alpha Al₂O₃), it may be present as crystalline Al₂O₃ and/or as part of one or more crystalline complex Al₂O₃.metal oxides.

### DETAILED DESCRIPTION

In general, ceramics according to the present invention can be made by heating (including in a flame) the appropriate metal oxide sources to form a melt, desirably a homogenous melt, and then rapidly cooling the melt to provide glass or ceramic comprising glass. Glass and ceramics comprising glass according to the present invention can be made, for example, by heating (including in a flame) the appropriate metal oxide sources to form a melt, desirably a homogenous melt, and then rapidly cooling the melt to provide glass. Embodiments of glass can be made, for example, by melting the metal oxide sources in any suitable furnace (e.g., an inductive heated furnace, a gas-fired furnace, or an electrical furnace), or, for example, in a plasma. The resulting melt is cooled (e.g., discharging the melt into a cooling media (e.g., high velocity air jets, liquids (such as water), metal plates (including chilled metal plates), metal rolls (including chilled metal rolls), metal balls (including chilled metal balls), and the like)).

Embodiments of glass can also be obtained by other techniques, such as: laser spin melt with free fall cooling, Taylor wire technique, plasmatron technique, hammer and anvil technique, centrifugal quenching, air gun splat cooling, single roller and twin roller quenching, roller-plate quenching and pendant drop melt extraction (see, e.g., Rapid Solidification of Ceramics, Brockway et. al., Metals And Ceramics Information Center, A Department of Defense Information Analysis Center, Columbus, Ohio, January, 1984). Embodiments of glass may also be obtained by other techniques, such as: thermal (including flame or laser or plasma-assisted) pyrolysis of suitable precursors, physical vapor synthesis (PVS) of metal precursors and mechanochemical processing.

In one method, glass useful for the present invention can be made utilizing flame fusion as disclosed, for example, in U.S. Pat. No. 6,254,981 (Castle). In this method, the metal oxide sources materials are fed (e.g., in the form of particles, sometimes referred to as “feed particles”) directly into a burner (e.g., a methane-air burner, an acetylene-oxygen burner, a hydrogen-oxygen burner, and like), and then quenched, for example, in water, cooling oil, air, or the like. Feed particles can be formed, for example, by grinding, agglomerating (e.g., spray-drying), melting, or sintering the metal oxide sources. The size of feed particles fed into the flame generally determines the size of the resulting glass particles/beads.

Glasses that are useful in the methods of the present invention include those that comprise at least two different metal oxides and contain less than 20% by weight SiO₂, less than 20% by weight B₂O₃, less than 40% by weight P₂O₅, and less than 50% by weight PbO. Useful glasses have a Tg and Tx, and the difference between the Tg and the Tx is at least 5K (preferably, at least 25K, or at least 50K).

Preferably, the glass is a REO-Al₂O₃ glass. Certain useful REO-Al₂O₃ glasses comprise 30% to 70% by weight Re(I)₂O₃, zero to 20% by weight Re(II)₂O₃, and 15% to 40% by weight Al₂O₃ (preferably, 20% to 35% by weight Al₂O₃), wherein Re(I) is La or Gd or combinations thereof and Re(II) is Ce, Pr, Nd, Sm, Eu, Tb, Dy, Ho, Tm, Y, or Yb, or combinations thereof.

In some embodiments, the REO-Al₂O₃ glass comprises 5% to 40% by weight ZrO₂, TiO₂, alkali metal oxide, alkaline metal oxide, transition metal oxide, or a combination thereof.

In some embodiments, the REO-Al₂O₃ glass comprises zero to 15% by weight SiO₂.

In some embodiments, the REO-Al₂O₃ glass comprises more than 70% by weight Re(I)₂O₃, Al₂O₃, and at least one of ZrO₂, TiO₂, alkali metal oxide, and alkaline earth metal oxide collectively (preferably, more than 70% by weight Re(I)₂O₃, Al₂O₃, and ZrO₂ collectively). In other embodiments, REO-Al₂O₃ glass comprises more than 70% by weight Re(I)₂O₃, Al₂O₃ and at least one of ZrO₂, HfO₂, TiO₂, or combinations thereof

In some embodiments, the REO-Al₂O₃ glass comprises Al₂O₃ in a % by weight less than (% by weight Re(I)₂O₃—10%).

In some embodiments, the REO-Al₂O₃ glass comprises 40% to 65% by weight Re(I)₂O₃ (preferably, 45% to 60% by weight Re(I)₂O₃). In other embodiments, the REO-Al₂O₃ glass comprises 30% to 65% by weight Re(I)₂O₃ (preferably, 35% to 55% by weight Re(I)₂O₃).

In some embodiments, the REO-Al₂O₃ glass comprises 5% to 25% by weight ZrO₂ and HfO₂ (preferably, 5% to 25% by weight ZrO₂ and HfO₂) collectively. In other embodiments, the REO-Al₂O₃ glass comprises 5% to 40% by weight at least one of ZrO₂, HfO₂, TiO₂, or combinations thereof (preferably, 5% to 35% by weight at least one of ZrO₂, HfO₂, TiO₂, or combinations thereof; more preferably, 15% to 35% by weight at least one of ZrO₂, HfO₂, TiO₂, or combinations thereof).

A preferred REO-Al₂O₃ glass comprises 30% to 70% by weight Re(I)₂O₃; zero to 20% by weight Re(II)₂O₃; 15% to 40% by weight Al₂O₃; 5% to 40% by weight ZrO₂, TiO₂, alkali metal oxide, alkaline metal oxide, transition metal oxide, or a combination thereof; zero to 15% by weight SiO₂; more than 70% by weight Re(I)₂O₃, Al₂O₃, and at least one of ZrO₂, TiO₂, alkali metal oxide, and alkaline earth metal oxide collectively; and has Al₂O₃ in a % by weight less than (% by weight Re(I)₂O₃—10%).

Another preferred REO-Al₂O₃ glass comprises 40% to 65% by weight Re(I)₂O₃; zero to 20% by weight Re(II)₂O₃; 15% to 40% by weight Al₂O₃; 5% to 25% by weight ZrO₂ and HfO₂ collectively; zero to 15% by weight SiO₂; more than 70% by weight Re(I)₂O₃, Al₂O₃, and ZrO₂ collectively; and has Al₂O₃ in a % by weight less than (% by weight Re(I)₂O₃—10%).

Yet another preferred REO-Al₂O₃ glass comprises 35% to 55% by weight Re(I)₂O₃; zero to 20% by weight Re(II)₂O₃; 15% to 40% by weight Al₂O₃; 5% to 40% by weight at least one of ZrO₂, HfO₂, TiO₂, or combinations thereof; zero to 15% by weight SiO₂; more than 70% by weight Re(I)₂O₃, Al₂O₃, and at least one of ZrO₂, HfO₂, or TiO₂; and has Al₂O₃ in a % by weight less than (% by weight Re(I)₂O₃—10%).

Still another preferred REO-Al₂O₃ glass comprises 45% to 60% by weight Re(I)₂O₃; zero to 20% by weight Re(II)₂O₃; 20% to 35% by weight Al₂O₃; 5% to 20% by weight ZrO₂ and HfO₂ collectively; zero to 15% by weight SiO₂; more than 70% by weight Re(I)₂O₃, Al₂O₃, and ZrO₂ collectively; and has Al₂O₃ in a % by weight less than (% by weight Re(I)₂O₃—10%).

Certain ceramic articles made according to the present invention contain less than less than 20% by weight SiO₂ (or even less than 15%, less than 10%, less than, 5% by weight, or even zero percent, by weight, SiO₂), less than 20% by weight B₂O₃ (or even less than 15%, less than 10%, less than, 5% by weight, or even zero percent, by weight, B₂O₃), less than 40% by weight P₂O₅ (or even less than 35%, less than 30%, less than 25%, less than 20%, less than 15%, less than 10%, less than, 5% by weight, or even zero percent, by weight, P₂O₅), and less than 50% by weight PbO (or even less than 25%, less than 10%, or even zero percent, by weight PbO) based on the total metal oxide weight of the ceramic.

Examples of useful glass for carrying out the present invention include those comprising CaO—Al₂O₃, CaO—Al₂O₃—ZrO₂, BaO—TiO₂, La₂O₃—TiO₂, REO-Al₂O₃, REO-Al₂O₃—ZrO₂, REO-Al₂O₃—ZrO₂—SiO₂, and SrO—Al₂O₃—ZrO₂ glasses. Useful glass formulations include those at or near a eutectic composition. In addition to the CaO—Al₂O₃, CaO—Al₂O₃—ZrO₂, BaO—TiO₂, La₂O₃—TiO₂, REO-Al₂O₃, REO-Al₂O₃—ZrO₂, REO-Al₂O₃—ZrO₂—SiO₂, and SrO—Al₂O₃—ZrO₂ compositions disclosed herein, other compositions, including eutectic compositions, will be apparent to those skilled in the art after reviewing the present disclosure. For example, phase diagrams depicting various compositions, including eutectic compositions, are known in the art.

Surprisingly, it was found that ceramics of present invention could be obtained without limitations in dimensions. This was found to be possible through a coalescence step performed at or below ambient pressure and at temperatures above glass transition temperature. As used herein, “ambient pressure” includes pressures up to about 3 atmospheres. It does not exclude situations wherein a slight backpressure is utilized during sintering/coalescing. Coalescing can be carried out in any of a variety of ways, including those known in the art for heat-treating glass to provide glass-ceramics. For example, coalescing can be conducted in batches, for example, using resistive, inductively or gas heated furnaces. Alternatively, for example, coalescing can be conducted continuously, for example, using rotary kilns. In the case of a rotary kiln, the material is fed directly into a kiln operating at the elevated temperature. The time at the elevated temperature may range from a few seconds (in some embodiments even less than 5 seconds) to a few minutes to several hours. The temperature may range anywhere from 700° C. to 1100° C., typically between 800° C. to 1000° C. It is also within the scope of the present invention to perform some of the coalescing in batches (e.g., for the nucleation step) and another continuously (e.g., for the crystal growth step and to achieve the desired density). For the nucleation step, the temperature typically ranges between about 800° C. to about 1000° C., in some embodiments, preferably in a range from about 850° C. to about 1000° C. This coalescing may occur, for example, by feeding the material directly into a furnace at the elevated temperature. Alternatively, for example, the material may be fed into a furnace at a much lower temperature (e.g., room temperature) and then heated to desired temperature at a predetermined heating rate. It is within the scope of the present invention to conduct coalescing in an atmosphere other than air. In some cases it might be even desirable to heat-treat in a reducing atmosphere(s).

Glass useful in carrying out the present invention undergoes glass transition (T_{g}) before significant crystallization occurs (Tₓ). This allows for bulk fabrication of articles of any dimensions from relatively small pieces of glass. More specifically, for example, an article according to the present invention can be provided by heating, for example, glass particles (including beads and microspheres), fibers, etc. useful in carrying out the present invention at or below ambient pressure to a temperature above the T_{g} such that the glass particles, etc. coalesce to form a shape and cooling the coalesced shape to provide the article. The resulting article can have dimensions greater than 500 microns (e.g., at least one dimension, or at least two dimensions, or even three dimensions (i.e., x, y, and z dimensions) greater than 500 microns). In certain embodiments, heating is conducted at least one temperature in a range of about 725° C. to about 1100° C.

Surprisingly, for certain embodiments according to the present invention, coalescence may be conducted at temperatures significantly higher than crystallization temperature (Tₓ). This is often the case when the material exhibits multiple crystallization events during heating. For example, if Tₓ₁ and Tₓ₂ crystallization temperatures are observed during a typical DTA scan, coalescing about Tx1 may be readily conducted and high densities may be achieved. Although not wanting to be bound by theory, it is believed the relatively slow kinetics of crystallization allow access to higher temperatures for viscous flow It is also within the scope of the present invention to conduct additional coalescence to further improve desirable properties of the article.

Sources, including commercial sources, of metal oxides such as Al₂O₃, BaO, CaO, rare earth oxides (e.g., CeO₂, Dy₂O₃, Er₂O₃, Eu₂O₃, Gd₂O₃, HO₂O₃, La₂O₃, Lu₂O₃, Nd₂O₃, Pr₆O₁₁, Sm₂O₃, Th₄O₇, Tm₂O₃, Yb₂O₃, and Yb₂O₃, and combinations thereof), TiO₂, ZrO₂ are known in the art. For example sources of (on a theoretical oxide basis) Al₂O₃ include bauxite (including both natural occurring bauxite and synthetically produced bauxite), calcined bauxite, hydrated aluminas (e.g., boehmite, and gibbsite), aluminum, Bayer process alumina, aluminum ore, gamma alumina, alpha alumina, aluminum salts, aluminum nitrates, and combinations thereof. The Al₂O₃ source may contain, or only provide, Al₂O₃. Alternatively, the Al₂O₃ source may contain, or provide Al₂O₃, as well as one or more metal oxides other than Al₂O₃ (including materials of or containing complex Al₂O₃.metal oxides (e.g., Dy₃Al₅O₁₂, Y₃Al₅O₁₂, CeAl₁₁O₁₈, etc.)).

Sources, including commercial sources, of rare earth oxides include rare earth oxide powders, rare earth metals, rare earth-containing ores (e.g., bastnasite and monazite), rare earth salts, rare earth nitrates, and rare earth carbonates. The rare earth oxide(s) source may contain, or only provide, rare earth oxide(s). Alternatively, the rare earth oxide(s) source may contain, or provide rare earth oxide(s), as well as one or more metal oxides other than rare earth oxide(s) (including materials of or containing complex rare earth oxide•other metal oxides (e.g., Dy₃Al₅O₁₂, CeAl₁₁O₁₈, etc.)).

Sources, including commercial sources, of (on a theoretical oxide basis) ZrO₂ include zirconium oxide powders, zircon sand, zirconium, zirconium-containing ores, and zirconium salts (e.g., zirconium carbonates, acetates, nitrates, chlorides, hydroxides, and combinations thereof). In addition, or alternatively, the ZrO₂ source may contain, or provide ZrO₂, as well as other metal oxides such as hafnia. Sources, including commercial sources, of (on a theoretical oxide basis) HfO₂ include hafnium oxide powders, hafnium, hafnium-containing ores, and hafnium salts. In addition, or alternatively, the HfO₂ source may contain, or provide HfO₂, as well as other metal oxides such as ZrO₂.

Sources, including commercial sources, of BaO include barium oxide powders, barium-containing ores, barium salts, barium nitrates, and barium carbonates. The barium oxide source may contain, or only provide, barium oxide. Alternatively, the barium oxide source may contain, or provide barium oxide, as well as one or more metal oxides other than barium oxide (including materials of or containing complex barium oxide•other metal oxides).

Sources, including commercial sources, of CaO include calcium oxide powders and calcium-containing ores. The calcium oxide(s) source may contain, or only provide, calcium oxide. Alternatively, the calcium oxide source may contain, or provide calcium oxide, as well as one or more metal oxides other than calcium oxide (including materials of or containing complex calcium oxide•other metal oxides).

Sources, including commercial sources, of rare earth oxides include rare earth oxide powders, rare earth metals, rare earth-containing ores (e.g., bastnasite and monazite), rare earth salts, rare earth nitrates, and rare earth carbonates. The rare earth oxide(s) source may contain, or only provide, rare earth oxide(s). Alternatively, the rare earth oxide(s) source may contain, or provide rare earth oxide(s), as well as one or more metal oxides other than rare earth oxide(s) (including materials of or containing complex rare earth oxide•other metal oxides (e.g., Dy₃Al₅O₁₂, CeAl₁₁O₁₈, etc.)).

Sources, including commercial sources, of SiO₂ include silica powders, silicon metals, and silicon-containing ores. The silicon oxide source may contain, or only provide, silicon oxide. Alternatively, the silicon oxide source may contain, or provide silicon oxide, as well as one or more metal oxides other than silicon oxide (including materials of or containing complex silicon oxide•other metal oxides).

Sources, including commercial sources, of SrO include strontium oxide powders, strontium carbonates, and strontium-containing ores. The strontium oxide source may contain, or only provide, strontium oxide. Alternatively, the strontium oxide source may contain, or provide strontium oxide, as well as one or more metal oxides other than strontium oxide (including materials of or containing complex strontium oxide•other metal oxides).

Sources, including commercial sources, of TiO₂ include titanium oxide powders, titanium metals and titanium-containing ores. The titanium oxide source may contain, or only provide, titanium oxide. Alternatively, the titanium oxide source may contain, or provide titanium oxide, as well as one or more metal oxides other than titanium oxide (including materials of or containing complex titanium oxide•other metal oxides).

Sources, including commercial sources, of (on a theoretical oxide basis) ZrO₂ include zirconium oxide powders, zircon sand, zirconium, zirconium-containing ores, and zirconium salts (e.g., zirconium carbonates, acetates, nitrates, chlorides, hydroxides, and combinations thereof). In addition, or alternatively, the ZrO₂ source may contain, or provide ZrO₂, as well as other metal oxides such as hafnia. Sources, including commercial sources, of (on a theoretical oxide basis) HfO₂ include hafnium oxide powders, hafnium, hafnium-containing ores, and hafnium salts. In addition, or alternatively, the HfO₂ source may contain, or provide HfO₂, as well as other metal oxides such as ZrO₂.

Optionally, ceramics according to the present invention further comprise additional metal oxides beyond those needed for the general composition. The addition of certain metal oxides may alter the properties and/or the crystalline structure or microstructure of ceramics made according to the present invention, as well as the processing of the raw materials and intermediates in making the ceramic. For example, oxide additions such as MgO, CaO, Li₂O, and Na₂O have been observed to alter both the T_{g} and Tₓ of glass. Although not wishing to be bound by theory, it is believed that such additions influence glass formation. Further, for example, such oxide additions may decrease the melting temperature of the overall system (i.e., drive the system toward lower melting eutectic), and ease of glass-formation. Complex eutectics in multi component systems (quaternary, etc.) may result in better glass-forming ability. The viscosity of the liquid melt and viscosity of the glass in its “working” range may also be affected by the addition of metal oxides beyond those needed for the general composition.

In some instances, it may be preferred to incorporate limited amounts of metal oxides selected from the group consisting of: Na₂O, P₂O₅, SiO₂, TeO₂, V₂O₃, and combinations thereof. Sources, including commercial sources, include the oxides themselves, complex oxides, ores, carbonates, acetates, nitrates, chlorides, hydroxides, etc. These metal oxides may be added, for example, to modify a physical property of the resulting abrasive particles and/or improve processing. These metal oxides when used are typically are added from greater than 0 to 20% by weight, preferably greater than 0 to 5% by weight and more preferably greater than 0 to 2% by weight of the glass-ceramic depending, for example, upon the desired property.

Further other glass compositions which may be used in conjunction with the required glass(es) for carrying out the present invention include those conventional glasses that are well known in the art, including sources thereof.

In some embodiments, ceramics made according to the present invention exhibit good light transmission after the coalescing step. Light transmission is a useful property for applications where optical translucency is desired. These materials can exhibit total light transmission of at least about 10%, about 20% or even about 30% through a one millimeter thick sample. Good light transmission can be obtained, for example, by coalescing glass particles to porosity levels below about 10% by volume (preferably below about 5%, 4%, 3%, 2% or even 1%), while maintaining size of crystallites that devitrify from glass to below about 200 nm (preferably, below about 150 nm; more preferably, below about 100 nm). Furthermore, in certain embodiments, transmission levels increase when initial glass particles comprise at least a bimodal distribution of particle sizes ranging from several microns to about 100 microns. Preferred particle assemblage includes up to 50% by volume of particles with an average size below about 10 microns, with the balance being particles with an average size of above about 20 microns.

In further embodiments, ceramics made according to present invention are useful as binders for inorganic fillers, even when used in concentrations below about 70% by volume. Such glass matrix composites are useful, for example, for various grinding wheels with super-abrasives (such as diamond and cubic-BN) and/or conventional abrasives (e.g., fused alumina, sol-gel alumina or fused alumina-zirconia). Compositions that are suitable for use as binders for inorganic fillers typically have low viscosity levels prior to crystallization. A preferred REO-Al₂O₃ glass for a grinding wheel matrix comprises 35% to 55% by weight Re(I)₂O₃; zero to 20% by weight Re(II)₂O₃; 15% to 40% by weight Al₂O₃; 5% to 40% by weight at least one of ZrO₂ , HfO₂ or TiO₂, or combinations thereof; zero to 15% by weight SiO₂; more than 70% by weight Re(I)₂O₃, Al₂O₃, and ZrO_{2,} TiO₂ or HfO₂; and has Al₂O₃ in a % by weight less than (% by weight Re(I)₂O₃—10%). Alkaline and alkaline earth oxides can also be added to decrease the viscosity of the liquid and to improve the adherence of fillers to the matrix.

For glasses that devitrify to form glass-ceramics, crystallization may also be affected by the additions of materials beyond those needed for the general composition. For example, certain metals, metal oxides (e.g., titanates and zirconates), and fluorides, for example, may act as nucleation agents resulting in beneficial heterogeneous nucleation of crystals. Also, addition of some oxides may change nature of metastable phases devitrifying from the glass upon reheating. In another aspect, for ceramics according to the present invention comprising crystalline ZrO₂, it may be desirable to add metal oxides (e.g., Y₂O₃, TiO₂, CaO, and MgO) that are known to stabilize tetragonal/cubic form of ZrO₂.

Examples of optional metal oxides (i.e., metal oxides beyond those needed for the general composition) may include, on a theoretical oxide basis, Al₂O₃, BaO, CaO, Cr₂O₃, CoO, Fe₂O₃, GeO₂, HfO₂, Li₂O, MgO, MnO, NiO, Na₂O, P₂O₅, rare earth oxides, Sc₂O₃, SiO₂, SrO, TeO₂, TiO₂, V₂O₃, Y₂O₃, ZnO, ZrO₂, and combinations thereof. Sources, including commercial sources, include the oxides themselves, complex oxides, ores, carbonates, acetates, nitrates, chlorides, hydroxides, etc. Further, for example, with regard to Y₂O₃, sources, including commercial sources, of (on a theoretical oxide basis) Y₂O₃ include yttrium oxide powders, yttrium, yttrium-containing ores, and yttrium salts (e.g., yttrium carbonates, nitrates, chlorides, hydroxides, and combinations thereof). The Y₂O₃ source may contain, or only provide, Y₂O₃. Alternatively, the Y₂O₃ source may contain, or provide Y₂O₃, as well as one or more metal oxides other than Y₂O₃ (including materials of or containing complex Y₂O₃.metal oxides (e.g., Y₃Al₅O₁₂)).

In some embodiments, it may be advantageous for at least a portion of a metal oxide source (in some embodiments, preferably, 10, 15, 20, 25, 30, 35, 40, 45, 50, 55, 60, 65, 70, 75, 80, 85, 90,or even at least 95 percent by weight) to be obtained by adding particulate, metallic material comprising at least one of a metal (e.g., Al, Ca, Cu, Cr, Fe, Li, Mg, Ni, Ag, Ti, Zr, and combinations thereof), M, that has a negative enthalpy of oxide formation or an alloy thereof to the melt, or otherwise metal them with the other raw materials. Although not wanting to be bound by theory, it is believed that the heat resulting from the exothermic reaction associated with the oxidation of the metal is beneficial in the formation of a homogeneous melt and resulting glass. For example, it is believed that the additional heat generated by the oxidation reaction within the raw material eliminates or minimizes insufficient heat transfer, and hence facilitates formation and homogeneity of the melt, particularly when forming amorphous particles with x, y, and z dimensions over 150 micrometers. It is also believed that the availability of the additional heat aids in driving various chemical reactions and physical processes (e.g., densification, and spherodization) to completion. Further, it is believed for some embodiments, the presence of the additional heat generated by the oxidation reaction actually enables the formation of a melt, which otherwise is difficult or otherwise not practical due to high melting point of the materials. Further, the presence of the additional heat generated by the oxidation reaction actually enables the formation of glass that otherwise could not be made, or could not be made in the desired size range. Another advantage of the invention include, in forming the glass, that many of the chemical and physical processes such as melting, densification and spherodizing can be achieved in a short time, so that very high quench rates be can achieved. For additional details, see copending application having U.S. Ser. No. 10/211,639, filed Aug. 2, 2002.

The particular selection of metal oxide sources and other additives for making ceramics according to the present invention typically takes into account, for example, the desired composition and microstructure of the resulting ceramics, the desired degree of crystallinity, if any, the desired physical properties (e.g., hardness or toughness) of the resulting ceramics, avoiding or minimizing the presence of undesirable impurities, the desired characteristics of the resulting ceramics, and/or the particular process (including equipment and any purification of the raw materials before and/or during fusion and/or solidification) being used to prepare the ceramics.

The metal oxide sources and other additives can be in any form suitable to the process and equipment utilized for the present invention. The raw materials can be melted and quenched using techniques and equipment known in the art for making oxide glasses and amorphous metals. Desirable cooling rates include those of 50K/s and greater. Cooling techniques known in the art include roll-chilling. Roll-chilling can be carried out, for example, by melting the metal oxide sources at a temperature typically 20-200° C. higher than the melting point, and cooling/quenching the melt by spraying it under high pressure (e.g., using a gas such as air, argon, nitrogen or the like) onto a high-speed rotary roll(s). Typically, the rolls are made of metal and are water cooled. Metal book molds may also be useful for cooling/quenching the melt.

Other techniques for forming melts, cooling/quenching melts, and/or otherwise forming glass include vapor phase quenching, plasma spraying, melt-extraction, and gas atomization. Vapor phase quenching can be carried out, for example, by sputtering, wherein the metal alloys or metal oxide sources are formed into a sputtering target(s) which are used. The target is fixed at a predetermined position in a sputtering apparatus, and a substrate(s) to be coated is placed at a position opposing the target(s). Typical pressures of 10⁻³ torr of oxygen gas and Ar gas, discharge is generated between the target(s) and a substrate(s), and Ar or oxygen ions collide against the target to start reaction sputtering, thereby depositing a film of composition on the substrate. For additional details regarding plasma spraying, see, for example, copending application having U.S. Ser. No. 10/211,640, filed Aug. 2, 2002.

Gas atomization involves melting feed particles to convert them to melt. A thin stream of such melt is atomized through contact with a disruptive air jet (i.e., the stream is divided into fine droplets). The resulting substantially discrete, generally ellipsoidal glass particles are then recovered. Melt-extraction can be carried out, for example, as disclosed in U.S. Pat. No. 5,605,870 (Strom-Olsen et al.). Containerless glass forming techniques utilizing laser beam heating as disclosed, for example, in PCT application having Publication No. WO 01/27046 A1, published Apr. 4, 2001, may also be useful in making glass according to the present invention.

The cooling rate is believed to affect the properties of the quenched glass. For instance, glass transition temperature, density and other properties of glass typically change with cooling rates.

Rapid cooling may also be conducted under controlled atmospheres, such as a reducing, neutral, or oxidizing environment to maintain and/or influence the desired oxidation states, etc. during cooling. The atmosphere can also influence glass formation by influencing crystallization kinetics from undercooled liquid. For example, larger undercooling of Al₂O₃ melts without crystallization has been reported in argon atmosphere as compared to that in air.

With regard to making particles, for example, the resulting ceramic (e.g., glass or ceramic comprising glass may be larger in size than that desired. The ceramic can be, and typically is, converted into smaller pieces using crushing and/or comminuting techniques known in the art, including roll crushing, canary milling, jaw crushing, hammer milling, ball milling, jet milling, impact crushing, and the like. In some instances, it is desired to have two or multiple crushing steps. For example, after the ceramic is formed (solidified), it may be in the form larger than desired. The first crushing step may involve crushing these relatively large masses or “chunks” to form smaller pieces. This crushing of these chunks may be accomplished with a hammer mill, impact crusher or jaw crusher. These smaller pieces may then be subsequently crushed to produce the desired particle size distribution. In order to produce the desired particle size distribution (sometimes referred to as grit size or grade), it may be necessary to perform multiple crushing steps. In general the crushing conditions are optimized to achieve the desired particle shape(s) and particle size distribution.

The shape of particles can depend, for example, on the composition of the glass, the geometry in which it was cooled, and the manner in which the glass is crushed (i.e., the crushing technique used), if the particles were formed by crushing.

Certain articles according to the present invention comprising glass can be heat-treated to increase or at least partially crystallize the glass (including crystallize the glass) to provide glass-ceramic. The heat-treatment of certain glasses to form glass-ceramics is well known in the art. The heating conditions to nucleate and grow glass-ceramics are known for a variety of glasses. Alternatively, one skilled in the art can determine the appropriate conditions from a Time-Temperature-Transformation (TTT) study of the glass using techniques known in the art. One skilled in the art, after reading the disclosure of the present invention should be able to provide TTT curves for glasses according to the present invention, determine the appropriate nucleation and/or crystal growth conditions to provide crystalline ceramics, glass-ceramics, and ceramic comprising glass according to the present invention. For some embodiments, two-step crystallization can be preferred. In two-step crystallization, at least two different temperatures are utilized for crystallization. The first crystallization step is conducted at a lower temperature and is typically referred to as a nucleation treatment. It can, for example, enhance the ceramic mechanical properties, reduce potential for breakage, and improve optical characteristics. The second crystallization step is conducted at a higher temperature and can be used, for example, to devitrify residual amorphous phase to further improve ceramic characteristics.

Heat-treatment can be carried out in any of a variety of ways, including those known in the art for heat-treating glass to provide glass-ceramics. For example, heat-treatment can be conducted in batches, for example, using resistive, inductively or gas heated furnaces. Alternatively, for example, heat-treatment can be conducted continuously, for example, using rotary kilns. In the case of a rotary kiln, the material is fed directly into a kiln operating at the elevated temperature. The time at the elevated temperature may range from a few seconds (in some embodiments even less than 5 seconds) to a few minutes to several hours. The temperature may range anywhere from 900° C. to 1600° C., typically between 1200° C. to 1500° C. It is also within the scope of the present invention to perform some of the heat-treatment in batches (e.g., for the nucleation step) and another continuously (e.g., for the crystal growth step and to achieve the desired density). For the nucleation step, the temperature typically ranges between about 900° C. to about 1100° C., in some embodiments, preferably in a range from about 925° C. to about 1050° C. Likewise for the additional crystallization/density step, the temperature typically is in a range from about 1100° C. to about 1600° C., in some embodiments, preferably in a range from about 1200° C. to about 1500° C. This heat treatment may occur, for example, by feeding the material directly into a furnace at the elevated temperature. Alternatively, for example, the material may be fed into a furnace at a much lower temperature (e.g., room temperature) and then heated to desired temperature at a predetermined heating rate. It is within the scope of the present invention to conduct heat-treatment in an atmosphere other than air. In some cases it might be even desirable to heat-treat in a reducing atmosphere(s).

Typically, glass-ceramics are stronger than the glasses from which they are formed. Hence, the strength of the material may be adjusted, for example, by the degree to which the glass is converted to crystalline ceramic phase(s). Alternatively, or in addition, the strength of the material may also be affected, for example, by the number of nucleation sites created, which may in turn be used to affect the number, and in turn the size of the crystals of the crystalline phase(s). For additional details regarding forming glass-ceramics, see, for example, Glass-Ceramics, P. W. McMillan, Academic Press, Inc., 2^{nd} edition, 1979.

For example, during heat-treatment of a glass such as a glass comprising Al₂O₃, La₂O₃, and ZrO₂ formation of phases such as La₂Zr₂O₇, and, if ZrO₂ is present, cubic/tetragonal ZrO₂, in some cases monoclinic ZrO₂, have been observed at temperatures above about 900° C. Although not wanting to be bound by theory, it is believed that zirconia-related phases are the first phases to nucleate from the glass. For example, of Al₂O₃, ReAlO₃ (wherein Re is at least one rare earth cation), ReAl₁₁O₁₈, Re₃Al₅O₁₂, Y₃Al₅O₁₂, etc. phases are believed to generally occur at temperatures above about 925° C. Crystallite size during this nucleation step may be on the order of nanometers. For example, crystals as small as 10-15 nanometers have been observed. Longer heat-treating temperatures typically lead to the growth of crystallites and progression of crystallization. For at least some embodiments, heat-treatment at about 1300° C. for about 1 hour provides a full crystallization.

The microstructure or phase composition (glassy/amorphous/crystalline) of a material can be determined in a number of ways. Various information can be obtained using optical microscopy, electron microscopy, differential thermal analysis (DTA), and x-ray diffraction (XRD), for example.

Using optical microscopy, glass is typically predominantly transparent due to the lack of light scattering centers such as crystal boundaries, while crystalline material shows a crystalline structure and is opaque due to light scattering effects.

Light transmission can be measured by a conventional transmission densitometer technique using a commercially available instrument such as, for example, a Macbeth model TD-504 densitometer.

Using DTA, the material is classified as amorphous if the corresponding DTA trace of the material contains an exothermic crystallization event (Tₓ). If the same trace also contains an endothermic event (T_{g}) at a temperature lower than Tₓ it is considered to consist of a glass phase. If the DTA trace of the material contains no such events, it is considered to contain crystalline phases.

Differential thermal analysis (DTA) can be conducted using the following method. DTA runs can be made (using an instrument such as that obtained from Netzsch Instruments, Selb, Germany under the trade designation “NETZSCH STA 409 DTA/TGA”) using a −140+170 mesh size fraction (i.e., the fraction collected between 105-micrometer opening size and 90-micrometer opening size screens). An amount of each screened sample (typically about 400 milligrams (mg)) is placed in a 100-microliter Al₂O₃ sample holder. Each sample is heated in static air at a rate of 10° C./minute from room temperature (about 25° C.) to 1100° C.

Using powder x-ray diffraction, XRD, (using an x-ray diffractometer such as that obtained under the trade designation “PHILLIPS XRG 3100” from Phillips, Mahwah, N.J., with copper K A1 radiation of 1.54050 Angstrom) the phases present in a material can be determined by comparing the peaks present in the XRD trace of the crystallized material to XRD patterns of crystalline phases provided in JCPDS (Joint Committee on Powder Diffraction Standards) databases, published by International Center for Diffraction Data. Furthermore, an XRD can be used qualitatively to determine types of phases. The presence of a broad diffused intensity peak is taken as an indication of the amorphous nature of a material. The existence of both a broad peak and well-defined peaks is taken as an indication of existence of crystalline matter within an amorphous matrix. The initially formed glass or ceramic (including glass prior to crystallization) may be larger in size than that desired. The glass or ceramic can be converted into smaller pieces using crushing and/or comminuting techniques known in the art, including roll crushing, canary milling, jaw crushing, hammer milling, ball milling, jet milling, impact crushing, and the like. In some instances, it is desired to have two or multiple crushing steps. For example, after the ceramic is formed (solidified), it may be in the form of larger than desired. The first crushing step may involve crushing these relatively large masses or “chunks” to form smaller pieces. This crushing of these chunks may be accomplished with a hammer mill, impact crusher or jaw crusher. These smaller pieces may then be subsequently crushed to produce the desired particle size distribution. In order to produce the desired particle size distribution (sometimes referred to as grit size or grade), it may be necessary to perform multiple crushing steps. In general the crushing conditions are optimized to achieve the desired particle shape(s) and particle size distribution. Resulting particles that are of the desired size may be recrushed if they are too large, or “recycled” and used as a raw material for re-melting if they are too small.

The shape of particles can depend, for example, on the composition and/or microstructure of the ceramic, the geometry in which it was cooled, and the manner in which the ceramic is crushed (i.e., the crushing technique used). In general, where a “blocky” shape is preferred, more energy may be employed to achieve this shape. Conversely, where a “sharp” shape is preferred, less energy may be employed to achieve this shape. The crushing technique may also be changed to achieve different desired shapes. For some particles an average aspect ratio ranging from 1:1 to 5:1 is typically desired, and in some embodiments 1.25:1 to 3:1, or even 1.5:1 to 2.5:1.

Ceramic articles (including glass-ceramics) made according to the present invention may comprise at least 1, 2, 3, 5, 10, 15, 20, 25, 30, 35, 40, 45, 50, 55, 60, 65, 70, 75, 80, 85, 90, 95, 97, 98, 99, or even 100 percent by volume crystallites, wherein the crystallites have an average size of less than 1 micrometer. In another aspect, ceramic articles (including glass-ceramics) made according to the present invention may comprise less than at least 1, 2, 3, 5, 10, 15, 20, 25, 30, 35, 40, 45, 50, 55, 60, 65, 70, 75, 80, 85, 90, 95, 97, 98, 99, or even 100 percent by volume crystallites, wherein the crystallites have an average size of less than 0.5 micrometer. In another aspect, ceramics (including glass-ceramics) according to the present invention comprise less than at least 1, 2, 3, 5, 10, 15, 20, 25, 30, 35, 40, 45, 50, 55, 60, 65, 70, 75, 80, 85, 90, 95, 97, 98, 99, or even 100 percent by volume crystallites, wherein the crystallites have an average size of less than 0.3 micrometer. In another aspect, ceramic articles (including glass-ceramics) made according to the present invention may comprise less than at least 1, 2, 3, 5, 10, 15, 20, 25, 30, 35, 40, 45, 50, 55, 60, 65, 70, 75, 80, 85, 90, 95, 97, 98, 99, or even 100 percent by volume crystallites, wherein the crystallites have an average size of less than 0.15 micrometer. In another aspect, ceramic articles (including glass-ceramics) made according to the present invention may be free of at least one of eutectic microstructure features (i.e., is free of colonies and lamellar structure) or a non-cellular microstructure.

In another aspect, certain ceramic articles made according to the present invention may comprise, for example, at least 1, 2, 3, 5, 10, 15, 20, 25, 30, 35, 40, 45, 50, 55, 60, 65, 70, 75, 80, 85, 90, 95, or even 100 percent by volume glass. In another aspect, certain ceramic articles made according to the present invention may comprise, for example, 100 or at least 1, 2, 3, 5, 10, 15, 20, 25, 30, 35, 40, 45, 50, 55, 60, 65, 70, 75, 80, 85, 90, 95, 97, 98, 99, or even 100 percent by volume crystalline ceramic.

Certain articles made according to the present invention comprise glass comprising CaO and Al₂O₃, wherein at least 80 (85, 90, 95, 97, 98, 99, or even 100) percent by weight of the glass collectively comprises the CaO and Al₂O₃, based on the total weight of the glass.

In another aspect, certain articles made according to the present invention provides a ceramic comprising glass (e.g., at least 5, 10, 15, 20, 25, 30, 35, 40, 45, 50, 55, 60, 65, 70, 75, 80, 85, 90, 95, 97, 98, 99, or even 100 percent by volume glass), the glass comprising CaO and Al₂O₃, wherein at least 80 (85, 90, 95, 97, 98, 99, or even 100) percent by weight of the glass collectively comprises the CaO and Al₂O₃, based on the total weight of the glass.

In another aspect, certain articles made according to the present invention provides glass-ceramic comprising CaO and Al₂O₃, wherein at least 80 (85, 90, 95, 97, 98, 99, or even 100) percent by weight of the glass-ceramic collectively comprises CaO and Al₂O₃, based on the total weight of the glass-ceramic. The glass-ceramic may comprise, for example, at least 1, 2, 3, 5, 10, 15, 20, 25, 30, 35, 40, 45, 50, 55, 60, 65, 70, 75, 80, 85, 90, or 95 percent by volume glass. The glass-ceramic may comprise, for example, at least 99, 98, 97, 95, 90, 85, 80, 75, 70, 65, 60, 55, 50, 45, 40, 35, 30, 25, 20, 15, 10, or 5 percent by volume crystalline ceramic.

Certain articles made according to the present invention comprise glass comprising CaO, Al₂O₃, and ZrO₂, wherein at least 80 (85, 90, 95, 97, 98, 99, or even 100) percent by weight of the glass collectively comprises the CaO, Al₂O₃, and ZrO₂, based on the total weight of the glass.

In another aspect, certain articles made according to the present invention provides a ceramic comprising glass (e.g., at least 5, 10, 15, 20, 25, 30, 35, 40, 45, 50, 55, 60, 65, 70, 75, 80, 85, 90, 95, 97, 98, 99, or even 100 percent by volume glass), the glass comprising CaO, Al₂O₃, and ZrO₂, wherein at least 80 (85, 90, 95, 97, 98, 99, or even 100) percent by weight of the glass collectively comprises the CaO and Al₂O₃, and ZrO₂, based on the total weight of the glass.

In another aspect, certain articles made according to the present invention provides glass-ceramic comprising CaO, Al₂O₃, and ZrO₂, wherein at least 80 (85, 90, 95, 97, 98, 99, or even 100) percent by weight of the glass-ceramic collectively comprises the CaO, Al₂O₃, and ZrO₂, based on the total weight of the glass-ceramic. The glass-ceramic may comprise, for example, at least 1, 2, 3, 5, 10, 15, 20, 25, 30, 35, 40, 45, 50, 55, 60, 65, 70, 75, 80, 85, 90, or 95 percent by volume glass. The glass-ceramic may comprise, for example, at least 99, 98, 97, 95, 90, 85, 80, 75, 70, 65, 60, 55, 50, 45, 40, 35, 30, 25, 20, 15, 10, or 5 percent by volume crystalline ceramic.

Certain articles made according to the present invention comprise glass comprising BaO and TiO₂, wherein at least 80 (85, 90, 95, 97, 98, 99, or even 100) percent by weight of the glass collectively comprises the BaO and TiO₂, based on the total weight of the glass.

In another aspect, certain articles made according to the present invention provides a ceramic comprising glass (e.g., at least 5, 10, 15, 20, 25, 30, 35, 40, 45, 50, 55, 60, 65, 70, 75, 80, 85, 90, 95, 97, 98, 99, or even 100 percent by volume glass), the glass comprising BaO and TiO₂, wherein at least 80 (85, 90, 95, 97, 98, 99, or even 100) percent by weight of the glass collectively comprises the BaO and TiO₂, based on the total weight of the glass.

In another aspect, certain articles made according to the present invention provides glass-ceramic comprising BaO and TiO₂, wherein at least 80 (85, 90, 95, 97, 98, 99, or even 100) percent by weight of the glass-ceramic collectively comprises the BaO and TiO₂, based on the total weight of the glass-ceramic. The glass-ceramic may comprise, for example, at least 1, 2, 3, 5, 10, 15, 20, 25, 30, 35, 40, 45, 50, 55, 60, 65, 70, 75, 80, 85, 90, or 95 percent by volume glass. The glass-ceramic may comprise, for example, at least 99, 98, 97, 95, 90, 85, 80, 75, 70, 65, 60, 55, 50, 45, 40, 35, 30, 25, 20, 15, 10, or 5 percent by volume crystalline ceramic.

Certain articles made according to the present invention comprise glass comprising La₂O₃ and TiO₂, wherein at least 80 (85, 90, 95, 97, 98, 99, or even 100) percent by weight of the glass collectively comprises the La₂O₃ and TiO₂, based on the total weight of the glass. In another aspect, certain articles made according to the present invention provides a ceramic comprising glass (e.g., at least 5, 10, 15, 20, 25, 30, 35, 40, 45, 50, 55, 60, 65, 70, 75, 80, 85, 90, 95, 97, 98, 99, or even 100 percent by volume glass), the glass comprising La₂O₃ and TiO₂, wherein at least 80 (85, 90, 95, 97, 98, 99, or even 100) percent by weight of the glass collectively comprises the La₂O₃ and TiO₂, based on the total weight of the glass.

In another aspect, certain articles made according to the present invention provides glass-ceramic comprising La₂O₃ and TiO₂, wherein at least 80 (85, 90, 95, 97, 98, 99, or even 100) percent by weight of the glass-ceramic collectively comprises the La₂O₃ and TiO₂, based on the total weight of the glass-ceramic. The glass-ceramic may comprise, for example, at least 1, 2, 3, 5, 10, 15, 20, 25, 30, 35, 40, 45, 50, 55, 60, 65, 70, 75, 80, 85, 90, or 95 percent by volume glass. The glass-ceramic may comprise, for example, at least 99, 98, 97, 95, 90, 85, 80, 75, 70, 65, 60, 55, 50, 45, 40, 35, 30, 25, 20, 15, 10, or 5 percent by volume crystalline ceramic.

Certain articles made according to the present invention comprise glass comprising REO and Al₂O₃, wherein at least 80 (85, 90, 95, 97, 98, 99, or even 100) percent by weight of the glass collectively comprises the REO and Al₂O₃, based on the total weight of the glass.

In another aspect, certain articles made according to the present invention provides a ceramic comprising glass (e.g., at least 5, 10, 15, 20, 25, 30, 35, 40, 45, 50, 55, 60, 65, 70, 75, 80, 85, 90, 95, 97, 98, 99, or even 100 percent by volume glass), the glass comprising REO and Al₂O₃, wherein at least 80 (85, 90, 95, 97, 98, 99, or even 100) percent by weight of the glass collectively comprises the REO and Al₂O₃, based on the total weight of the glass.

In another aspect, certain articles made according to the present invention provides glass-ceramic comprising REO and Al₂O₃, wherein at least 80 (85, 90, 95, 97, 98, 99, or even 100) percent by weight of the glass-ceramic collectively comprises the REO and Al₂O₃, based on the total weight of the glass-ceramic. The glass-ceramic may comprise, for example, at least 1, 2, 3, 5, 10, 15, 20, 25, 30, 35, 40, 45, 50, 55, 60, 65, 70, 75, 80, 85, 90, or 95 percent by volume glass. The glass-ceramic may comprise, for example, at least 99, 98, 97, 95, 90, 85, 80, 75, 70, 65, 60, 55, 50, 45, 40, 35, 30, 25, 20, 15, 10, or 5 percent by volume crystalline ceramic.

In another aspect, the present invention provides glass-ceramic comprising REO and Al₂O₃, wherein, for example, glass-ceramic exhibits a microstructure comprising crystallites having an average crystallite size of less than 1 micrometer (typically, less than 500 nanometers, even less than 300, 200, or 150 nanometers; and in some embodiments, less than 100, 75, 50, 25, or 20 nanometers), and (b) is free of at least one of eutectic microstructure features or a non-cellular microstructure. The glass-ceramic may comprise, for example, at least 1, 2, 3, 5, 10, 15, 20, 25, 30, 35, 40, 45, 50, 55, 60, 65, 70, 75, 80, 85, 90, 95, percent by volume glass. The glass-ceramic may comprise, for example, at least 99, 98, 97, 95, 90, 85, 80, 75, 70, 65, 60, 55, 50, 45, 40, 35, 30, 25, 20, 15, 10, or 5 percent by volume crystalline ceramic.

In another aspect, certain articles made according to the present invention provides a ceramic comprising glass (e.g., at least 5, 10, 15, 20, 25, 30, 35, 40, 45, 50, 55, 60, 65, 70, 75, 80, 85, 90, 95, 97, 98, 99, or even 100 percent by volume glass), the glass comprising REO, Al₂O₃, and ZrO₂, wherein at least 80 (85, 90, 95, 97, 98, 99, or even 100) percent by weight of the glass collectively comprises the REO and Al₂O₃ and ZrO₂, based on the total weight of the glass.

In another aspect, certain articles made according to the present invention provides glass-ceramic comprising REO, Al₂O₃, and ZrO₂, wherein at least 80 (85, 90, 95, 97, 98, 99, or even 100) percent by weight of the glass-ceramic collectively comprises the REO and Al₂O₃ and ZrO₂, based on the total weight of the glass-ceramic. The glass-ceramic may comprise, for example, at least 1, 2, 3, 5, 10, 15, 20, 25, 30, 35, 40, 45, 50, 55, 60, 65, 70, 75, 80, 85, 90, or 95 percent by volume glass. The glass-ceramic may comprise, for example, at least 99, 98, 97, 95, 90, 85, 80, 75, 70, 65, 60, 55, 50, 45, 40, 35, 30, 25, 20, 15, 10, or 5 percent by volume crystalline ceramic.

In another aspect, the present invention provides glass-ceramic comprising REO, Al₂O₃, and ZrO₂, wherein the glass-ceramic (a) exhibits a microstructure comprising crystallites having an average crystallite size of less than 1 micrometer (typically, less than 500 nanometers, even less than 300, 200, or 150 nanometers; and in some embodiments, less than 100, 75, 50, 25, or 20 nanometers), and (b) is free of at least one of eutectic microstructure features or a non-cellular microstructure. The glass-ceramic may comprise, for example, at least 1, 2, 3, 5, 10, 15, 20, 25, 30, 35, 40, 45, 50, 55, 60, 65, 70, 75, 80, 85, 90, 95, percent by volume glass. The glass-ceramic may comprise, for example, at least 99, 98, 97, 95, 90, 85, 80, 75, 70, 65, 60, 55, 50, 45, 40, 35, 30, 25, 20, 15, 10, or 5 percent by volume crystalline ceramic.

In another aspect, certain articles made according to the present invention provides a ceramic comprising glass (e.g., at least 5, 10, 15, 20, 25, 30, 35, 40, 45, 50, 55, 60, 65, 70, 75, 80, 85, 90, 95, 97, 98, 99, or even 100 percent by volume glass), the glass comprising REO, Al₂O₃, ZrO₂, and SiO₂ wherein at least 80 (85, 90, 95, 97, 98, 99, or even 100) percent by weight of the glass collectively comprises the REO and Al₂O₃ and ZrO₂, based on the total weight of the glass.

In another aspect, certain articles made according to the present invention provides glass-ceramic comprising REO, Al₂O₃, ZrO₂, and SiO₂, wherein at least 80 (85, 90, 95, 97, 98, 99, or even 100) percent by weight of the glass-ceramic collectively comprises the REO and Al₂O₃ and ZrO₂, based on the total weight of the glass-ceramic. The glass-ceramic may comprise, for example, at least 1, 2, 3, 5, 10, 15, 20, 25, 30, 35, 40, 45, 50, 55, 60, 65, 70, 75, 80, 85, 90, or 95 percent by volume glass. The glass-ceramic may comprise, for example, at least 99, 98, 97, 95, 90, 85, 80, 75, 70, 65, 60, 55, 50, 45, 40, 35, 30, 25, 20, 15, 10, or 5 percent by volume crystalline ceramic.

In another aspect, the present invention provides glass-ceramic comprising REO, Al₂O₃, ZrO₂, and SiO₂, wherein the glass-ceramic (a) exhibits a microstructure comprising crystallites having an average crystallite size of less than 1 micrometer (typically, less than 500 nanometers, even less than 300, 200, or 150 nanometers; and in some embodiments, less than 100, 75, 50, 25, or 20 nanometers), and (b) is free of at least one of eutectic microstructure features or a non-cellular microstructure. The glass-ceramic may comprise, for example, at least 1, 2, 3, 5, 10, 15, 20, 25, 30, 35, 40, 45, 50, 55, 60, 65, 70, 75, 80, 85, 90, 95, percent by volume glass. The glass-ceramic may comprise, for example, at least 99, 98, 97, 95, 90, 85, 80, 75, 70, 65, 60, 55, 50, 45, 40, 35, 30, 25, 20, 15, 10, or 5 percent by volume crystalline ceramic.

Crystalline phases that may be present in ceramics according to the present invention include alumina (e.g., alpha and transition aluminas), BaO, CaO, Cr₂O₃, CoO, Fe₂O₃, GeO₂, HfO₂, Li₂O, MgO, MnO, NiO, Na₂O, P₂O₅, REO, Sc₂O₃, SiO₂, SrO, TeO₂, TiO₂, V₂O₃, Y₂O₃, ZnO, ZrO₂, “complex metal oxides” (including “complex Al₂O₃□metal oxide (e.g., complex Al₂O₃□REO)), and combinations thereof.

Additional details regarding ceramics comprising Al₂O₃, at least one of REO or Y₂O₃, and at least one of ZrO₂ or HfO₂, including making, using, and properties, can be found in application having U.S. Ser. Nos. 09/922,527, 09/922,528, and 99/922,530, filed Aug. 2, 2001, and U.S. Ser. Nos. 10/211,598; 10/211,630; 10/211,639; 10/211,034; 10/211,044; 10/211,628; 10/211,640; and 10/211,684, filed Aug. 2, 2002.

Typically, and desirably, the (true) density, sometimes referred to as specific gravity, of ceramic according to the present invention is at least 70% of theoretical density. More desirably, the (true) density of ceramic according to the present invention is at least 75%, 80%, 85%, 90%, 95%, 96%, 97%, 98%, 99%, 99.5% or 100% of theoretical density.

Typically, and desirably, the porosity of ceramic according to the present invention is less than at least 25%, 20%, 15%, 10%, 5%, 4%, 3%, 2%, 1%, 0.5% or 0% by volume.

The density or porosity of ceramic articles according to the present invention can be measured using know test methods including, e.g., mercury porosimetry, gas pycnometry, or by using Archimedes Method.

Examples of articles according of the present invention include kitchenware (e.g., plates), dental materials, and reinforcing fibers, cutting tool inserts, abrasive materials, and structural components of gas engines, (e.g., valves and bearings). Additional information on use of the articles as dental materials can be found in U.S. Pat. No. 6,984,261 (Cummings et al.) and U.S. Pat. No. 7,022,173 (Cummings et al.) and U.S. Ser. Nos. 11/018,520 and 11/018,117, both filed Dec. 21, 2004. Other articles include those having a protective coating of ceramic on the outer surface of a body or other substrate. Further, for example, ceramic according to the present invention can be used as a matrix material. For example, ceramics according to the present invention can be used as a binder for ceramic materials and the like such as diamond, cubic-BN, Al₂O₃, ZrO₂, Si₃N₄, and SiC. Examples of useful articles comprising such materials include composite substrate coatings, cutting tool inserts abrasive agglomerates, and bonded abrasive articles such as vitrified wheels. The use of ceramics according to the present invention can be used as binders may, for example, increase the modulus, heat resistance, wear resistance, and/or strength of the composite article.

### Examples

Objects and advantages of this invention are further illustrated by the following examples, but the particular materials and amounts thereof recited in these examples, as well as other conditions and details, should not be construed to unduly limit this invention.

### Example 1

Example 1 material was prepared by charging a porcelain mill with 1090.4 grams of alumina particles obtained from Alcoa Industrial Chemicals, Bauxite, Ark., under the trade designation “A16SG”), 2096 grams of lanthanum oxide particles (obtained from Molycorp, Inc.), 600 grams of yttria-stabilized zirconium oxide particles (with a nominal composition of 94.6 wt-% ZrO₂ (+HfO₂) and 5.4 wt-% Y₂O₃; obtained under the trade designation “HSY-3” from Zirconia Sales, Inc. of Marietta, Ga.), 240 grams of silicon dioxide powder, 1600 grams of isopropyl alcohol, 40 g of a dispersant Solsperse 2000, 120 g of a PVP binder and about 3000 grams of alumina milling media (cylindrical shape, both height and diameter of 0.635 cm; 99.9% alumina; obtained from Coors, Golden, Colo.).

The contents of the porcelain mill were milled for 16 hours at 60 revolutions per minute (rpm). After the milling, the milling media were removed and the slurry was poured onto a warm (about 75° C.) glass (“PYREX”) pan in a layer, and allowed to cool and dry in an oven at 110° C. The dried mixture was ground by screening through a 30-mesh screen (600-micrometer opening size) with the aid of a paintbrush and calcined at 1325° C., in air, for two hours in an electrically heated furnace (obtained from CM Furnaces, Bloomfield, N.J. under the trade designation “Rapid Temp Furnace”).

The sintered mixture was graded to retain the −80+100 mesh fraction (i.e., the fraction collected between 180 micrometer opening size and 150 micrometer opening size screens, with a mean particle size of about 165 micrometer). The resulting screened particles were fed slowly (about 0.5 gram/minute) through a funnel, which was attached to a powder feeder, under a nitrogen gas atmosphere 5 standard liter per minute (SLPM), into a hydrogen/oxygen torch flame which melted the particles and carried them directly into a 19-liter (5-gallon) rectangular container (41 centimeters (cm) by 53 cm by 18 cm height) of continuously circulating, turbulent water (20° C.) to rapidly quench the molten droplets. The powder feeder comprised a canister (8 cm diameter) at the bottom of which was a 70-mesh screen (212 micrometer opening size). The powder was filled into the canister and was forced through the openings of the screen using a rotating brush. The torch was a Bethlehem bench burner PM2D Model B obtained from Bethlehem Apparatus Co., Hellertown, Pa. The torch had a central feed port (0.475 cm ( 3/16 inch) inner diameter) through which the feed particles were introduced into the flame. Hydrogen and oxygen flow rates for the torch were as follows. The hydrogen flow rate was 42 standard liters per minute (SLPM) and the oxygen flow rate was 18 SLPM. The angle at which the flame hit the water was approximately 90°, and the flame length, burner to water surface, was approximately 38 centimeters (cm). The resulting (quenched) particles were collected in a pan and heated at 110° C. in an electrically heated furnace till dried (about 30 minutes). The particles were clear glass, spherical in shape and varied in size from 50 micrometers up to 180 micrometer, with a mean particle size of about 90 micrometers.

For differential thermal analysis (DTA), the particles were screened to retain beads in the 90-125 micrometer size range. DTA runs were made (using an instrument obtained from Netzsch Instruments, Selb, Germany under the trade designation “NETZSCH STA 409 DTA/TGA”). The amount of the screened sample placed in a 100-microliter Al₂O₃ sample holder was 400 milligrams. The sample was heated in static air at a rate of 10° C./minute from room temperature (about 25° C.) to 1200° C.

Glass transition temperature of the glass was determined to be 830° C. and crystallization temperature was 1010° C.

About 8 grams of the beads sized between 50 and 106 microns were placed in an alumina crucible, lightly tapped to increase compaction densities and inserted into an electrically heated furnace (obtained under the trade designation “Model KKSK-666-3100” from Keith Furnaces of Pico Rivera, Calif.) preheated to 1000 C. After holding at temperature for 8 m in at ambient pressure, the crucible was removed from the furnace. Surprisingly, beads were fully coalesced into a free-standing cylindrical body which was white in appearance. Density of the sintered compact was measured by the Archimedes technique to be 95.7%.

### Example 2

50 grams of as prepared beads of Example 1 were crushed using sapphire mortar and pestel to an approximate particle size of between 20 and 50 microns. About 8 grams of the crushed beads were sintered as described in example 1, except that the holding time was reduced to 6 min. Free-standing yellowish cylindrical body translucent in appearance was obtained. Density of the sintered compact was measured to be 99.1%.

Two millimeter thick disk of the material was cut from the cylindrical block and optical transmission was measured using “Macbeth TD504” opacity meter. Transmission was found to be 29%.

### Example 3

300 g of beads prepared in Example 1 were jet-milled using a ceramic-lined mill to generate glass powder with particle size between 5 and 12 microns. 8 grams of the milled powder was placed into a steel die and uniaxially pressed at 45 ksi to form a free standing green body. The green body was sintered as described in Example 2, except the holding time was reduced to 6 min. Dense, yellowish and mostly opaque free standing cylindrical block was obtained. Density of this material was measured to be 99.5%

### Example 4

4 g of jet-milled glass particles of Example 3 were mixed with 2 g of diamond powder (30 micron average size). The mixture was loaded into a steel die and uniaxially compressed at 100 MPa to form a free standing green body. The composite was subsequently sintered as described in Example 1. Opaque free standing cylindrical block with greenish color (which was the color of the starting diamond powder) was obtained.

### Example 5

4 g of jet-milled glass particles of Example 3 were placed in an alumina crucible and lightly tapped. W—Re (6%) wire was placed in the middle of the crucible which was then subjected to the heating cycle of the Example 1. Opaque free standing cylindrical block fully encapsulating the wire was obtained.

### Examples 6-21

Examples 6-21 were prepared essentially as described in Example 1, except with the compositions reported in Table 1.

TABLE 1

| Ex. | | | | | | | | | | | | | | |
|---|---|---|---|---|---|---|---|---|---|---|---|---|---|---|
| No. | Y₂O₃ | Gd₂O₃ | La₂O₃ | ZrO₂ | SiO₂ | Al₂O₃ | Nb₂O₅ | MgO | TiO₂ | BaO | Li₂CO₃ | Tg | Tₓ₁ | Tₓ₂ |
| 6 | | | 50.5 | 15 | | 34.5 | | | | | | 829 | 972 | |
| 7 | | | 51.5 | 14.7 | | 33.8 | | | | | | 830 | 975 | |
| 8 | | | 52.5 | 14.4 | | 33.1 | | | | | | 828 | 980 | |
| 9 | | | 53.5 | 14.1 | | 32.4 | | | | | | 830 | 974 | |
| 10 | | | 49.5 | 15.3 | | 35.2 | | | | | | 831 | 970 | |
| 11 | | 5 | 45.5 | 15 | | 34.5 | | | | | | 831 | 969 | |
| 12 | 5 | | 45.5 | 15 | | 34.5 | | | | | | 831 | 970 | |
| 13 | 4.5 | 7.2 | 40.7 | 2.45 | 6.11 | 27.8 | 5.28 | 0.8 | 1.6 | 3.04 | 0.6 | 801 | 958 | |
| 14 | | | 39.4 | 11.24 | 10 | 25.86 | | | | 4.5 | 9 | 839 | 1005 | |
| 15 | | | 39.4 | 11.24 | 5 | 25.86 | | 5 | | 4.5 | 9 | 821 | 975 | |
| 16 | | | 48.5 | 12 | | 38.5 | | | | | | 830 | 955 | |
| 17 | | | 52.6 | 15 | 6 | 27.4 | | | | | | 831 | 1006 | |
| 18 | | | 41 | 30 | 10 | 19 | | | | | | 834 | 901 | 1027 |
| 19 | | | 45.8 | | 11.2 | 21.2 | | | 21.7 | | | 812 | 889 | 1005 |
| 20 | 2 | | 48 | 19.3 | 5.85 | 24.85 | | | | | | 842 | 943 | 998 |
| 21 | | | 43.4 | 15 | 10.6 | 20.1 | | | 10.9 | | | 814 | 924 | 1004 |

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1-22. (canceled)

23. The method of claim 28 further comprising providing a second glass and heating the first glass and the second glass above at least the T_{g} of the first glass, wherein at least the first glass coalesces with the second glass to provide the article.

24-27. (canceled)

28. A method of making an article comprising:
providing at least a first plurality of particles comprising glass, wherein the glass comprises at least two different metal oxides, wherein the glass has a T_{g} and Tₓ, and wherein the difference between the T_{g} and the Tₓ of the glass is at least 5K, the glass containing less than 20% by weight SiO₂, less than 20% by weight B₂O₃, less than 40% by weight P₂O₅, and less than 50% by weight PbO; and
heating the glass at or below ambient pressure to above the T_{g} and coalescing at a portion of the first plurality of particles to provide the article,
wherein the porosity of the ceramic is less than 20% by volume.

29. The method of claim 28 wherein the glass is a REO-Al₂O₃ glass.

30. The method of claim 29 wherein the glass comprises
30%-70% by weight Re(I)₂O₃,
0-20% by weight Re(II)₂O₃, and
15%-40% by weight Al₂O₃,
wherein Re(I)=La or Gd or combinations thereof, and
Re(II)=Ce, Pr, Nd, Sm, Eu, Tb, Dy, Ho, Tm, Y, or Yb, or combinations thereof

33. The method of claim 29 wherein the first comprises 5%-40% by weight ZrO₂, TiO₂, alkali metal oxide, alkaline earth metal oxide, transition metal oxide, or a combination thereof.

32. The method of claim 29 wherein the glass comprises in a range from 0 to 15% by weight SiO₂.

33. The method of claim 29 wherein the glass comprises more than 70% by weight Re(I)₂O₃, Al₂O₃, and at least one of ZrO₂, TiO₂, alkali metal oxide, and alkaline earth metal oxide collectively.

34. The method of claim 33 wherein the glass comprises more than 70% by weight Re(I)₂O₃, Al₂O₃, and ZrO₂ collectively.

35. The method of claim 29 wherein the glass comprises Al₂O₃ in a % by weight less than (% by weight Re(I)₂O₃—10%).

36. The method of any of claim 29 wherein the glass comprises 30%-65% by weight Re(I)₂O₃.

37. The method of claim 36 wherein the glass comprises in a range from 35% to 55% by weight Re(I)₂O₃.

38. The method of claim 29 wherein the glass comprises in a range from 5% to 40% by weight at least one of ZrO₂, HfO₂, TiO₂, or combinations thereof.

39. The method of claim 38 wherein the glass comprises in a range from 15% to 35% by weight at least one of ZrO₂, HfO₂, TiO₂, or combinations thereof.

40. The method of claim 29 wherein the glass comprises in a range from 20% to 35% by weight Al₂O₃.

41. The method of claim 29 wherein the glass comprises
35%-55% by weight Re(I)₂O₃,
0-20% by weight Re(II)₂O₃,
15%-40% by weight Al₂O₃,
5%-40% by weight at least one of ZrO₂, HfO₂, TiO₂, or combinations thereof,
0-15% by weight SiO₂, and
more than 70% by weight Re(I)₂O₃, Al₂O₃, and at least one of ZrO₂, HfO₂, or TiO₂; and
wherein % by weight Al₂O₃ is less than (% by weight Re(I)₂O₃—10%).

42. The method of claim 41 wherein the glass comprises
20%-35% by weight Al₂O₃, and
5%-35% by weight at least one of ZrO₂, HfO₂, TiO₂, or combinations thereof.

43. The method of claim 29 wherein the difference of the T_{g} and the Tₓ of the glass is at least 25K.

44. The method of claim 43 wherein the difference of the T_{g} and the Tₓ of the glass is at least 50K.

45. The method of claim 44 wherein the difference of the T_{g} and the Tₓ of the glass is at least 100K.

46. The method of claim 29 wherein the porosity of the ceramic is less than 15% by volume.

47. The method of claim 46 wherein the porosity of the ceramic is less than 10% by volume.

48. The method of claim 47 wherein the porosity of the ceramic is less than 5% by volume.

49. The method of claim 29 further comprising heat-treating the first glass to provide glass-ceramic.

50. (canceled)

51. (canceled)

52. A ceramic article comprising a glass comprising:
30%-55% by weight Re(I)₂O₃,
0-20% by weight Re(II)₂O₃,
wherein Re(I)═La or Gd or combinations thereof, and
Re(II)═Ce, Pr, Nd, Sm, Eu, Tb, Dy, Ho, Tm, Y, or Yb, or combinations thereof,
5%-40% by weight ZrO₂, TiO₂, alkali metal oxide, alkaline earth metal oxide, transition metal oxide, or a combination thereof,
0-15% by weight SiO₂, and
more than 70% by weight Re(I)₂O₃, Al₂O₃, and at least one of ZrO₂, TiO₂, alkali metal oxide, and alkaline earth metal oxide collectively;
wherein Al₂O₃ is present in an amount less than (% by weight Re(I)₂O₃—10%);
wherein the glass has a T_{g} and Tₓ, and wherein the difference between the T_{g} and the Tₓ of the glass is at least 100K.

53. (canceled)

54. (canceled)

55. The ceramic article of claim 52 wherein the porosity of the ceramic article is less than 20% by volume.

56. The ceramic article of claim 55 wherein the porosity of the ceramic article is less than 15% by volume.

57. The ceramic article of claim 56 wherein the porosity of the ceramic article is less than 10% by volume.

58. (canceled)
